(19) United States
(12) Patent Application Publication
(10) Pub. No.: US 2011/0216745 A1
(43) Pub. Date: Sep. 8, 2011

(54) SYSTEM AND METHOD FOR SIGNALING OVERHEAD INFORMATION IN A NETWORK

(75) Inventors: Fuyun Ling, San Diego, CA (US); Krishna K. Mukkavilli, San Diego, CA (US); Ralph A. Gholmieh, San Diego, CA (US); Bojan Vrcelj, San Diego, CA (US)

(73) Assignee: QUALCOMM Incorporated, San Diego, CA (US)

(21) Appl. No.: 12/876,958

(22) Filed: Sep. 7, 2010

Related U.S. Application Data
(60) Provisional application No. 61/240,944, filed on Sep. 9, 2009.

(51) Int. Cl. H04W 72/04; H04W 88/00

(52) U.S. Cl. 370/336; 370/328

(57) ABSTRACT

A system for signaling overhead information in a network includes a receiver configured to receive a radio frequency communication signal comprising at least one superframe, the at least one superframe comprising overhead information that identifies a location of a first data stream carried in the at least one superframe, and a trailer associated with the first data stream, the trailer including at least a portion of the overhead information that identifies the location of the first data stream in a subsequent superframe without the receiver processing the overhead information in the subsequent superframe.

### CROSS REFERENCE TO RELATED APPLICATION

This application claims priority to and the benefit of the filing date of U.S. Provisional Application No. 61/240,944, entitled “Method For Signaling Overhead information In a Broadcast Network” filed on Sep. 9, 2009, the entirety of which is incorporated herein by reference.

### BACKGROUND

The continued development and implementation of wireless communications systems has made it possible to transmit a large amount of data over a radio frequency (RF) air interface. There are a number of technologies that can be used to broadcast video and other programming from a central location to a receiver device. Forward Link Only (FLO) is an example of a transmission methodology that uses a radio frequency (RF) air interface to broadcast video and other programming from one or more central locations to one or more receiver devices. The basic structure of a transmission block in FLO is referred to as a “superframe.” In one implementation, a superframe contains 1200 MAC time units and has a duration of one (1) second. A superframe contains pilot, control and data frames. Typically, four data frames, each containing one or both of wide-area and local-area data are part of a superframe.

The FLO methodology has been improved to increase bandwidth and data carrying capability. The enhanced FLO system is referred to as FLO-EV. The enhanced FLO-EV system introduced additional physical layer transmit modes and allows additional services and capacity to be carried on the FLO network. In addition, it is also possible to increase the bandwidth of such networks by using multiple radio frequency (RF) channels over which to transport the FLO and the FLO-EV data.

The FLO and FLO-EV data can be received by a variety of portable communications devices, which are referred to herein as a receiver. The receiver is typically a battery powered portable device, such as a cell phone, a personal digital assistant, or another portable device capable of receiving and displaying the data. One of the design goals is to extend the time between recharging the power source. One of the ways to accomplish this goal is to make the receiver device as efficient as possible by, for example, processing only as much received data as is necessary to successfully decode and display the received data stream.

As used herein the term FLO transmitter and FLO receiver refers to transmitters and receivers that are compliant with Revisions 0 and A of TIA-1099. The term FLO-EV and FLO-EV receiver refers to transmitters and receivers that are compliant with Revision B of TIA 1099. In particular, a FLO-EV multicast logical channel (MLC) is an MLC that is compliant with Revision B of TIA 1099, but not compliant with earlier releases. A FLO-EV MLC is either a physical layer type 2 (PHY Type 2) MLC that is encoded with a turbo code that spans the bits in the 4 frames of a superframe, or a physical layer type 1 (PHY Type 1) MLC that is encoded similarly to Rev A of TIA-1099 but that has a different trailer and OIS (overhead information symbol) location record structure to allow a larger peak rate on the MLC.

In a FLO communication system, each superframe includes a portion of the overhead information for the next superframe, thus making it possible to decode the next superframe without necessarily decoding all of the overhead information in the superframe. This is referred to as “embedding” the overhead information in the body of a superframe. However, due to the coding structure used in FLO-EV, which uses a long turbo codeword with a time interleaver spanning an entire superframe, the decoding delay imposed by such a structure may make it difficult to decode the entire superframe before the start of a next superframe, thus making it difficult to obtain the embedded overhead information within the span of one superframe.

Therefore, it would be desirable to have a way to overcome this limitation for a FLO-EV communication system.

### SUMMARY

Embodiments of the invention include a system for signaling overhead information in a network, comprising a receiver configured to receive a radio frequency communication signal comprising at least one superframe, the at least one superframe comprising overhead information that identifies a location of a first data stream carried in the at least one superframe, and a trailer associated with the first data stream, the trailer including at least a portion of the overhead information that identifies the location of the first data stream in a subsequent superframe without the receiver processing the overhead information in the subsequent superframe.

Other embodiments are also provided. Other systems, methods, features, and advantages of the invention will be or become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE FIGURES

The invention can be better understood with reference to the following figures. The components within the figures are not necessarily to scale, emphasis instead being placed upon clearly illustrating the principles of the invention. Moreover, in the figures, like reference numerals designate corresponding parts throughout the different views.

FIG. 1 is a block diagram illustrating the basic elements of a forward link only (FLO) network.

FIG. 2 is a block diagram illustrating a portion of a receiver of the portable communication device of FIG. 1.

FIG. 3 is a block diagram illustrating an example of a superframe suitable for carrying FLO and FLO-EV data.

FIG. 4 is a graphical illustration showing a frame portion containing example multicast logical channels.

FIG. 5 is a diagram illustrating the system parameters message (SystemParameters Message) carried in the wide area OIS (or local-area OIS) of FIG. 3.

FIGS. 6A through 6D are diagrams illustrating various additional fields of the SystemParameters Message of FIG. 5 as it relates to an MLC Records Table.

FIGS. 6E through 6H are diagrams illustrating various additional fields of the SystemParameters Message of FIG. 5 as it relates to an extended MLC Records Table.

FIG. 7 is a block diagram illustrating the relationship among an MLC, the OIS, and the control channel (CC).

FIGS. 8A through 8C are diagrams illustrating various additional fields of the SystemParameters Message of FIG. 5.

FIGS. 9A through 9C are diagrams illustrating various additional fields of the SystemParameters Message of FIG. 5.

FIG. 10 is a diagram illustrating a portion of a data stream received by a portable communication device.

FIG. 11 is a flowchart describing an exemplary power up sequence of a portable communication device of FIG. 1

FIG. 12 is a flowchart describing flow acquisition in a portable communication device of FIG. 1.

### DETAILED DESCRIPTION

The system and method for signaling overhead information in a network will be described in the context of a receiver in a portable communication device having the ability to receive and discriminate between multiple data streams.

The system and method for signaling overhead information in a network can be implemented in hardware, software, or a combination of hardware and software. When implemented in hardware, the system and method for signaling overhead information in a network can be implemented using specialized hardware elements and logic. When portions of the system and method for signaling overhead information in a network are implemented in software, the software can be used to control the various components in a receiver of a portable communication device.

The software can be stored in a memory and executed by a suitable instruction execution system (microprocessor). The hardware portion of the system and method for signaling overhead information in a network can include any or a combination of the following technologies, which are all well known in the art: discrete electronic components, a discrete logic circuit(s) having logic gates for implementing logic functions upon data signals, an application specific integrated circuit having appropriate logic gates, a programmable gate array(s) (PGA), a field programmable gate array (FPGA), etc.

The system and method for signaling overhead information in a network comprises an ordered listing of executable instructions for implementing logical functions, and can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM), a read-only memory (ROM), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via for instance, optical scanning of the paper or other medium, then compiled, interpreted or otherwise processed in a suitable manner if necessary, and then stored in a computer memory.

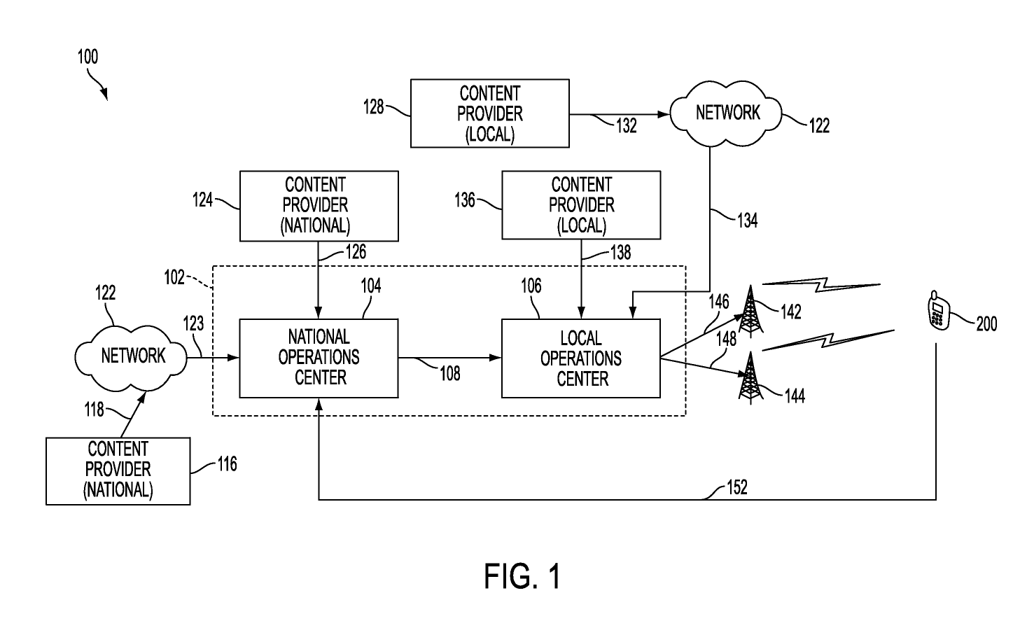

FIG. 1 is a block diagram illustrating the basic elements of a forward link only (FLO) network. The flow network 100 comprises a network operations center 102 one or more flow transmitters 142, 144, a reverse link 152 and one or more portable communication devices 200. In an embodiment, the network operations center 102 comprises a national operations center 104 and a local operations center 106. The national operations center 104 provides a national multiplex distribution stream over connection 108 to the local operations center 106. The connection 108 can be any high capacity communications channel.

The network operations center 102 receives content from a number of different sources over a number of different paths. Content may include, but is not limited to, data, audio, video, television programming, or other content. For example, the national operations center 104 can receive national content from a content provider 124 directly over a connection 126. The connection 126 can be a direct physical connection, a wireless connection or any other connection over which content can be provided to the national operations center 104. Alternatively, the national operations center 104 can receive national content from a content provider 116 over a network 122. The network 122 can be any of a wide area, a local area, or any other communications network over which content can be received over connection 118 from the content provider 116 and provided over connection 123 to the national operations center 104.

Similarly, the local operations center 106 can receive local content directly from a content provider 136 over connection 138. The connection 138 can be similar to the connection 126. Alternatively, the local operations center 106 can receive local content from a content provider 128 over the network 122 via connection 134. National content is content that can be provided to all portable communication devices 200, while local content is content that can be provided to a subset of all portable communication devices based on geographical location.

The network operations center provides the content to a wireless broadcast network embodied by transmitters 142 and 144. The transmitters 142 and 144 are intended to illustrate the entire infrastructure used to receive a terrestrial-based communication signal over connections 146 and 148, and to provide a wireless transmission to the portable communication device 200. While the details of the FLO network are known to those having ordinary skill in the art, it should be mentioned that the FLO network is a diversity-type network in which multiple transmitters (e.g., transmitters 142 and 144) are used to send multiple signals having identical content from a number of transmitters to each portable device 200. The portable communication device 200 comprises any mobile or portable communication device, such as, for example, a cell phone, a personal digital assistant (PDA), a wireless television receiver, or any other portable communication device. The portable communication device 200 includes a receiver configured to receive the FLO transmission from the transmitters 142 and 144. Further, it is possible for the transmission to occur from the transmitters 142 and 144 to the portable communication device 200 using more than one RF channel. As an example, FLO data can be carried over a first RF channel having a first radio frequency and FLO-EV data can be carried over a second RF channel having a second radio frequency.

The portable communication device 200 is also coupled to the national operations center 104 via a reverse link 152. In an embodiment, the reverse link 152 can be a 3G, or a 4G wireless communication channel provided by a cellular communication carrier or provider. The reverse link 152 allows the portable communication device 200 to submit registration and authentication information to the national operations center 104 so that the portable communication device 200 receives the appropriate content. However, it should be mentioned that the transmission of content from the network operations center, via the flow transmitters 142 and 144, to the portable communication device 200 are one way only.

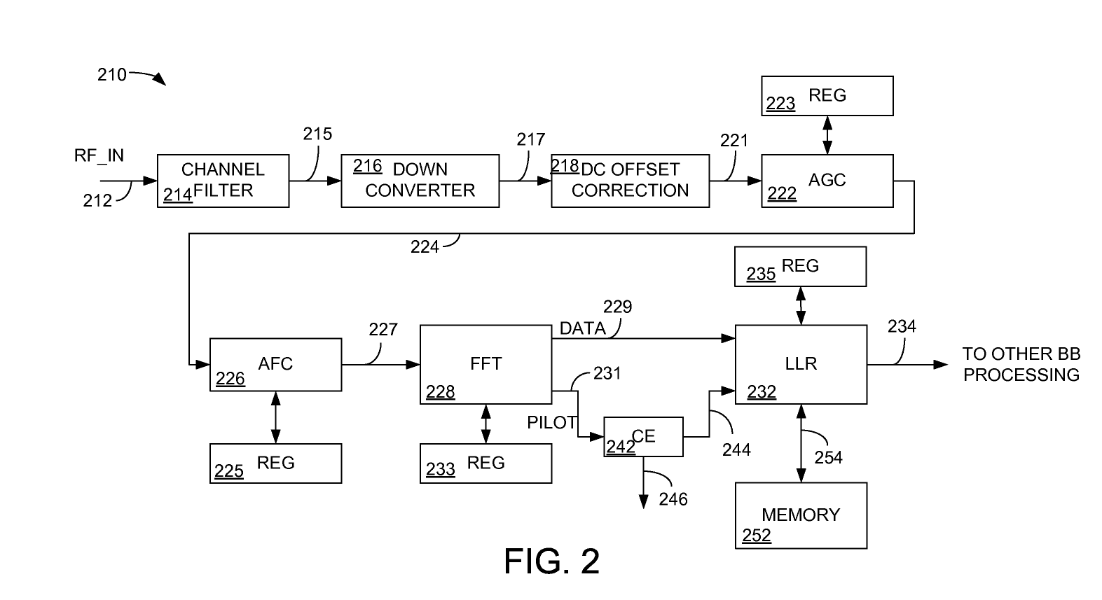

FIG. 2 is a block diagram illustrating a portion of a receiver of the portable communication device 200 of FIG. 1. The receiver portion 210 shown in FIG. 2 illustrates only the basic components of a receiver within the portable communication device 200. Details of a receiver are known to those having ordinary skill in the art. The receiver portion 210 receives a radio frequency (RF) signal over connection 212. The received RF signal is provided to a channel filter 212, which filters the received RF signal to develop a signal on connection 215 at the desired receive frequency. The RF signal on connection 215 is an analog signal that has undergone initial receiver processing, which may also include one or more of switching, low noise amplification or other front end receiver processing to prepare the RF signal for decoding.

The signal on connection 215 is provided to a downconverter 216. The downconverter 216 translates the signal on connection 215 from an RF signal to either an intermediate frequency (IF) or to baseband, or near-baseband if the receiver is implemented as a direct conversion receiver.

The signal on connection 217 is provided to a DC offset correction element 218, which corrects for any DC offset imparted to the signal in connection 217. The output of the DC offset correction element 218 is provided over connection 221 to an automatic gain control (AGC) element 222. The AGC element 222 adjusts the gain of the signal on connection 221 and provides a gain adjusted signal on connection 224. The AGC element 222 may comprises one or more analog and/or digital gain stages and can also convert the analog signal on connection 221 to a digital signal on connection 224.

The output on connection 224 is provided to an automatic frequency control (AFC) element 226. The AFC element 226 stabilizes the frequency of the signal on connection 224 and provides an output over connection 227 to the FFT element 228. The FFT element 228 provides a data output over connection 229 and provides a pilot symbol output over connection 231.

The data output of the FFT element 228 on connection 229 is provided to a log likelihood ratio (LLR) generator 232, which performs signal processing, and provides the data output to a turbo decoding element (not shown), and other processing elements over connection 234. The pilot symbol signal provided on connection 231 is provided to a channel estimate (CE) element 242. The CE element 242 provides the pilot symbol over connection 244 to the LLR generator 232 and also provides an estimate of the channel energy for each symbol over connection 246. A memory 252 is coupled to the LLR generator 232 over connection 254. The memory can be used to store the information on connections 229 and 244, and can be used to store the software for the system and method for signaling overhead information in a network.

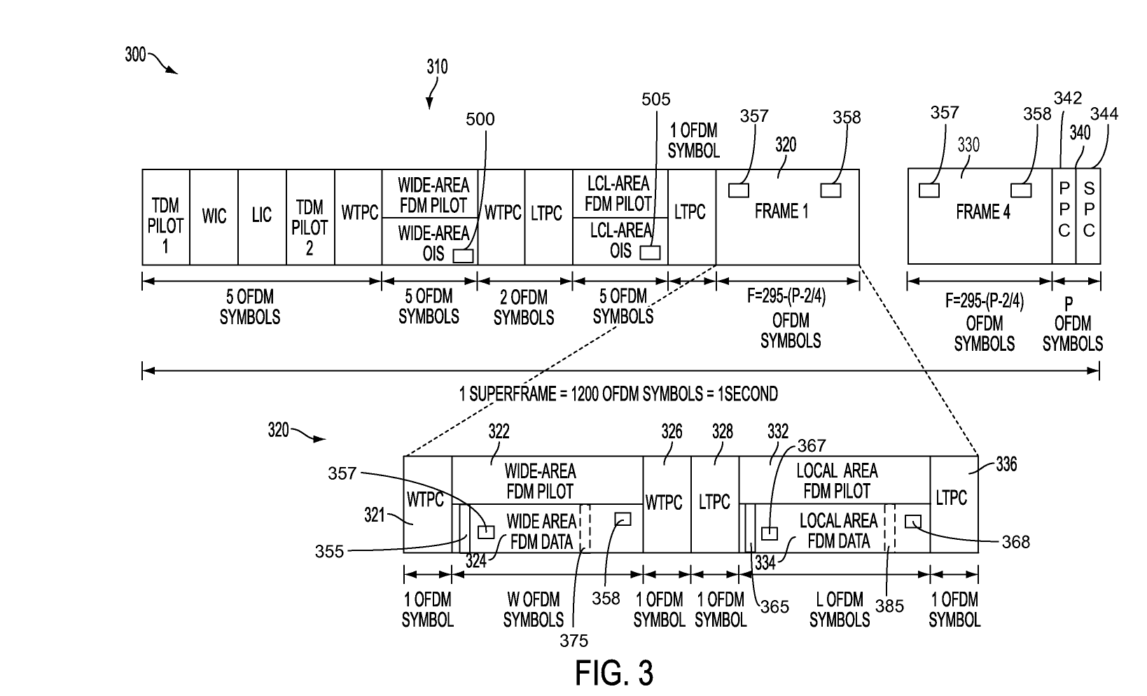

FIG. 3 is a block diagram illustrating an example of a superframe 300 suitable for carrying FLO and FLO-EV data over one or more RF channels. In an embodiment, the superframe 300 can be assembled by the network operations center 102 (FIG. 1) for transmission to the portable communication device 200 (FIG. 1). The superframe 300 comprises a preamble portion 310 that comprises pilot and OIS (overhead information symbol) information, frames 320 and 330, and portion 340, which includes positional pilot channel (PPC) 342 and signaling parameter channel (SPC) 344. The SPC 344 includes two bits that are used to indicate the physical device type (PHY Type 1 or PHY Type 2) for the particular radio frequency (RF), and includes two bits to indicate PPC status. By indicating the physical device type in the SPC 344 for the particular RF, the portable communication device 200 can determine whether it can receive and decode the contents of that particular RF.

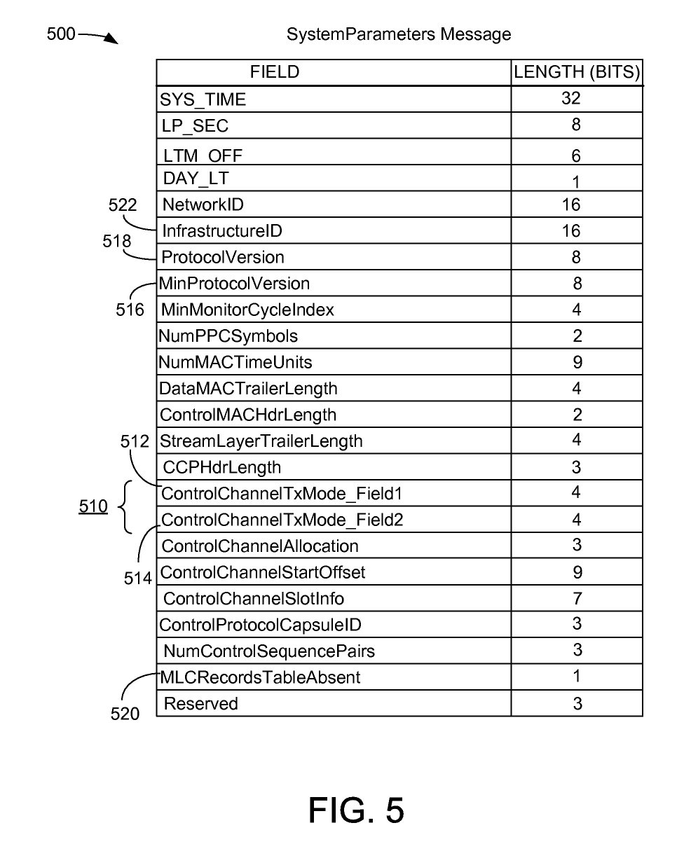

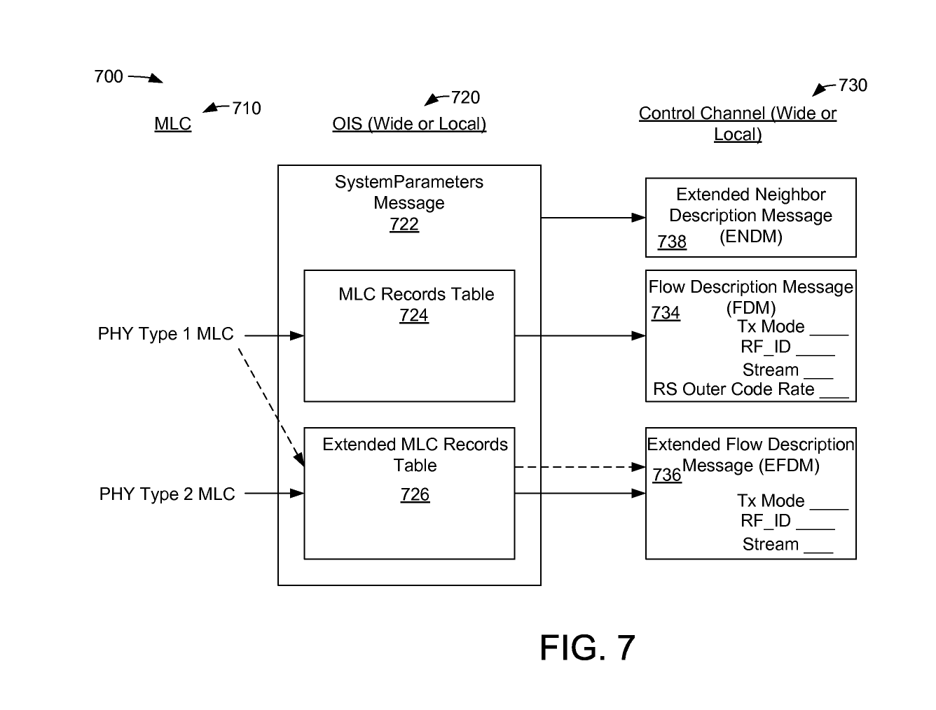

Furthermore, the PHY Type of an RF channel and PPC information can be listed in an extended neighbor description message (ENDM) (FIG. 7) to provide the device with prior knowledge of the encoding of other RF channels in the same local-area operational infrastructure (LOI), or of the RF channels in neighboring LOIs. An LOI is identified by the Infrastructure ID value (field 522 in FIG. 5) in the Local OIS. An LOI is the smallest geographic area over which the same set of multiplexed signals are broadcast over the exact same RF channels in the same manner. Thus, obtaining the ENDM and FDM and EFDM in the current LOI is sufficient to determine on which RF channel a flow is broadcast in the current LOI. The ENDM carries the mapping between RF_IDs used in the FDM and EFDM to identify RF channels, and physical RF channels characterized by the SPC parameters. The same content may be broadcast in two neighboring LOIs. If such is the case, then the LOI ID is a geographical identifier and can be used, for example, to determine whether certain channels are blacked out. Details of the fields in an ENDM are shown below.

The preamble 310 comprises 18 OFDM symbols in which TDM pilot channels occupy the first four symbols and a wide area transition pilot channel (WTPC) occupies the fifth symbol. The next five symbols are divided among wide area FDM pilot and wide area OIS information. The wide area OIS information portion includes a system parameters message 500, which will be described in greater detail below. The following two symbols comprise wide area transition pilot channel (WTPC) information and local area transition pilot channel (LTPC) information, while the following five symbols are divided between local area FDM pilot information and local area OIS information. The local area OIS information portion also includes a system parameters message 505, similar to the systems parameter message 500, for local OIS information. The following symbol comprises a local area transition pilot channel (LTPC).

Frames one through four are similar in structure so only frame one, 320, will be described in detail. Frame one, 320, comprises a wide area transition pilot channel (WTPC) 321 occupying a first symbol, “W” symbols comprising wide area FDM pilot information 322 and wide area FDM data 324, a single OFDM symbol comprising WTPC information 326, a single OFDM symbol comprising LTPC information 328, “L” OFDM symbols comprising local area FDM pilot information 322 and local area FDM data 334, followed by a single OFDM symbol 336 comprising the LTPC.

The superframe 300 can comprise both wide area and local area data, depending on system application. Further, in an embodiment, the superframe 300 can comprise data streams having both FLO and FLO-EV data. A FLO-EV multicast logical channel (MLC) is an MLC that is compliant with Revision B of TIA 1099, but not compliant with earlier releases. A FLO-EV MLC is either a physical layer type 2 (PHY Type 2) MLC that is encoded with a turbo code that spans the bits in the 4 frames of a superframe, or a physical layer type 1 (PHY Type 1) MLC that is encoded similarly to Rev A of TIA-1099 but that has a different trailer and OIS (overhead information symbol) location record structure to allow a larger peak rate on the MLC. A device capable of receiving PHY Type 1 is able to decode transmit modes specific to PHY Type 1 transport. Similarly, a device capable of receiving PHY Type 2 is able to decode transmit modes specific to PHY Type 2 transport. A PHY Type 1 transmit mode carries the data in what is referred to as a PHY Type 1 multicast logical channel (MLC) and a PHY Type 2 transmit mode carries the data in a PHY Type 2 mLC. The term “transmit mode” refers to the transmit scheme used to send information from the transmitters 142, 144, to the portable communication device 200 (FIG. 1). A PHY Type 1 transmit mode generally uses a first set of RF carrier frequencies and a PHY Type 2 transmit mode generally uses a second set of RF carrier frequencies.

A PHY Type 1 transmit mode may be used to send the superframe 300 containing FLO data to a portable communication device 200; a PHY Type 2 transmit mode may used to send the superframe 300 containing FLO-EV data to a portable communication device 200; and PHY Type 1 and PHY Type 2 transmit modes may be used to send the superframe 300 containing FLO data and FLO-EV data to a portable communication device 200. Further, in an embodiment, FLO data and FLO-EV data can be transported in the same superframe or in different superframes. In another embodiment, only FLO data is transported in a superframe, and in another embodiment only FLO-EV data is sent in a superframe.

A portable communication device 200 can be implemented in a variety of ways to receive any or all of FLO and FLO-EV data in either or both of a PHY Type 1 transmit mode or a PHY Type 2 transmit mode, whether in the same superframe or in different superframes. In an embodiment, and for example purposes only, the portable communication device 200 can be considered a class 1 device that can receive and decode FLO data; a class 2 device that can receive and decode FLO-EV data; a class 3 device that can receive and decode FLO data and FLO-EV data in separate superframes, i.e., the device can either decode the FLO data being broadcast or the FLO-EV data being broadcast, but not both, in one superframe; and a class 4 device that can receive and decode FLO data and FLO-EV data in the same superframe.

In an embodiment, there is no restriction on the location of FLO (PHY Type 1 device and MLC) and FLO-EV (PHY Type 2 device and MLC) and either or both of PHY Type 1 transmit modes and PHY Type 2 transmit modes. Corresponding MLCs may be carried anywhere within the wide area FDM data portion 324. Similarly, either or both of PHY Type 1 transmit modes and PHY Type 2 transmit modes, and corresponding MLCs, may be carried anywhere within the local area FDM data portion 334.

The wide area FDM data portion 324 comprises a control channel (CC) multicast logical channel (MLC) 355, and for example purposes only, comprises a FLO MLC 357 and a FLO-EV MLC 358. Similarly, the local area FDM data portion 334 comprises a control channel (CC) multicast logical channel (MLC) 365, and for example purposes only, comprises a FLO MLC 367 and a FLO-EV MLC 368. Control information associated with the CC MLC 355 is delivered to the wide service area over a plurality of radio frequency channels is identical regardless of transmit mode. Similarly, control information associated with the CC MLC 365 that is delivered to the local service area over a plurality of radio frequency channels is identical regardless of transmit mode.

In addition, the wide area FLO-EV data portion 354 may optionally include a wide area FLO-EV CC MLC 375; and the local area FLO-EV data portion 364 may optionally include a local area FLO-EV CC MLC 385. The inclusion of a wide area FLO-EV CC MLC 375 and a local area FLO-EV CC MLC 385 allows a control channel to be sent in a network that includes both PHY Type 1 devices and PHY Type 2 devices, and in a network that includes only PHY Type 2 devices. Furthermore, this embodiment is compatible with the first 3 classes of devices mentioned above, since a device would always be able to decode updates to the control channel to enable continued reception of data flows.

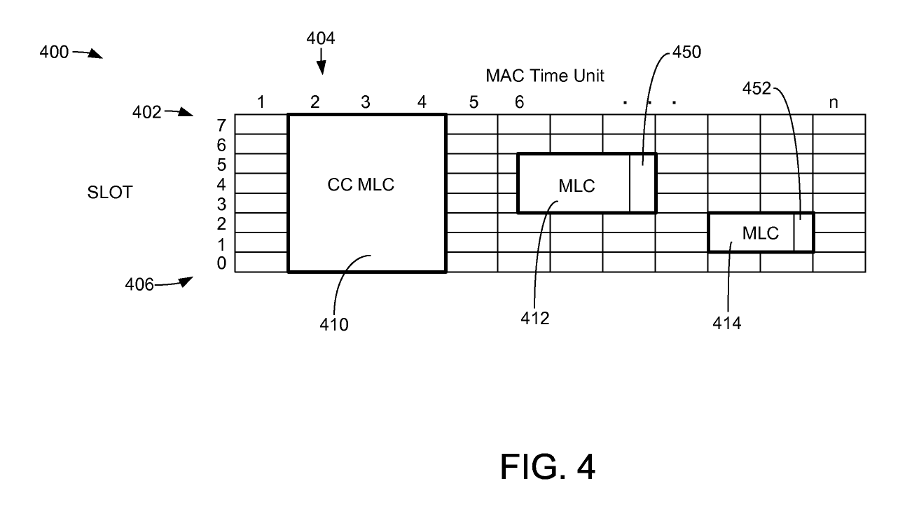

FIG. 4 is a graphical illustration 400 showing a frame portion 402 containing example multicast logical channels. The frame portion 402 can be part of either the wide area FDM data portion 324 (FIG. 3) or the local area FDM data portion 334 (FIG. 3). The frame portion 402 comprises a number (“W” or “L” of FIG. 3, depending on whether the subject frame contains wide area or a local area data) of symbols that can occur, for example, within the data portion 324 or 334 of the frame 320 of FIG. 3. The frame portion 402 contains a number of MAC time units 404, which are each further subdivided into eight (8) slots 406. Each slot is further mapped to an interlace, which is a physical layer concept representing a set of ⅛ subcarriers spaced regularly across the FFT bandwidth. In one implementation, this mapping may be designed such that the data sent over an MLC experiences significant frequency diversity.

In general, one MAC time unit is either ½ (if FFT=8K), 1 (if FFT=4K), 2 (if FFT=2K) or 4 (if FFT=1 K) OFDM symbols. A MAC time unit may be spread over multiple OFDM symbols. Each MLC is mapped to MAC time units. For example purposes only, a control channel (CC) multicast logical channel (MLC) 410 is shown as spanning MAC time units 2, 3 and 4, and occurs within all of the slots 406.

For example purposes only, a first multicast logical channel (MLC) 412 is shown as spanning MAC time units 6, 7 and 8, and as occurring within slots 3-5. A second exemplary MLC 414 is shown as spanning MAC time units n−2 and n−1, and occurs within slots 1 and 2. The MLCs 412 and 414 can be either a FLO (PHY Type 1) MLC or a FLO-EV (PHY Type 2) MLC, and include a MAC trailer. For example, the MLC 412 includes a MAC trailer 450 and the MLC 414 includes a MAC trailer 452. The MAC trailer (450 and 452) may include a portion of the information carried in the system parameters message (500, 505) provided in the OIS (FIG. 3). This so called “embedded OIS” will be described in greater detail below.

FIG. 5 is a diagram illustrating the system parameters message (SystemParameters Message) 500 carried in the wide area OIS (and 505 when carried in the local-area OIS) of FIG. 3. The SystemParameters Message comprises a number of information fields that define FLO and FLO-EV data, carried by PHY Type 1 and PHY Type 2 transmit modes, respectively, and that can also indicate the radio frequency (RF) information for different transmit modes. As an example, to support the availability of both FLO and FLO-EV data, the fields 510 are modified from that used in deployments with only PHY Type 1 transmit mode to accommodate a PHY Type 2 transmit mode as well. Previously, when carrying only PHY Type 1 MLCs, the field 512 referred to the transmit mode (modes 0 to 11, where modes 12 to 15 are unused), and the field 514 was the outer-code mode (0000=no outer code, 1=14/16, 2=12/16, 3=8/16). This arrangement still applies if the subject MLC is PHY Type 1. If the subject MLC is a PHY Type 2 mLC, then the field 514 contains the 4 most significant bits of the 8 bit PHY Type 2 transmit mode, and the field 512 contains the 4 least significant bits of the 8 bit PHY Type 2 transmit mode. The following values of {field2} {field1} (field 514/field 512) are in use: {0000} {0000-1011} (i.e. values 0 to 11 indicating PHY Type 1 modes 0 to 11 with no outer code), {0001} {0000-1011} (i.e. values 16 to 27 indicating PHY Type 1 modes 0 to 11 with RS(14,16) outer code), {0010} {0000-1011} (i.e. values 32 to 43 indicating PHY Type 1 modes 0 to 11 with RS(12,16) outer code), {0011} {0000-1011} (i.e. values 48 to 59 indicating PHY Type 1 modes 0 to 11 with RS(8,16) outer code). This is the reason that PHY Type 2 transmit modes start at 64. It is possible to have filled the numerical gaps and used modes 12, 13, 14, 15, 28, 29, etc., but such would be less practical from a usability point of view. Therefore, possible combinations include FLO=>PHY Type 1 transmit modes, and new combinations for the two fields=>8 bit transmit mode numbers (PHY Type 2 modes are 64 to 72, and 80 to 91).

The field 512 comprises four (4) available bits for ControlChannelTXMode_Field1 information and the field 514 comprises four (4) available bits for ControlChannelTXMode_Field2 information. By including the fields 512 and 514, the SystemParameters Message 500 can signal to the receiver 210 within the portable communication device 200, a specific transmit mode that can support FLO and/or FLO-EV data. For example, the fields 512 and 514 can be used to carry information relating to a physical type 1 transmit mode that carries a first type MLC (PHY Type 1 mLC) or the fields 512 and 514 can be used to carry information relating to a physical type 2 transmit mode that carries a second type MLC (PHY Type 2 mLC). A PHY Type 1 mLC and a PHY Type 2 mLC can be carried on the same RF channel or on different RF channels. In still another embodiment, a new field could be added to signal the presence of a second control channel with the understanding that the two control channels would carry the same data, but that one control channel would use a PHY Type 1 transmit mode for FLO devices, and that the second control channel would use a PHY Type 2 transmit mode for a) greater coverage, and/or b) ability of devices decoding PHY Type 2 MLCs to simultaneously decode the control channel without requiring the receiver to be able to decode PHY Type 1 and PHY Type 2 MLCs simultaneously.

The SystemParametersMessage 500 also includes a minimum protocol version (MinProtocolVersion) field 516. The field 516 is used to signal the minimum protocol version specified for the portable communication device 200 to receive a particular flow. For example, when the control channel MLC is sent using a transmit mode associated with FLO data (PHY Type 1) the MinProtocolVersion field 516 can be set to a logic “0” indicating that all devices can decode and interpret the OIS and the control channel. When the control channel MLC is sent using a transmit mode associated with FLO-EV data (PHY Type 2) the MinProtocolVersion field 516 can be set to a logic “2” indicating that PHY Type 1 devices cannot decode and interpret the OIS and the control channel.

The SystemParametersMessage 500 also includes a protocol version (ProtocolVersion) field 518. The field 518 is used to signal the current version of the Forward Link Only system protocol supported by the infrastructure. For example, in deployments where OIS and control channel are signaled using a PHY Type 1 transmit mode, and the data MLCs are sent using both PHY Type 1 and PHY Type 2 transmit modes, field 516 of the SystemParametersMessage 500 may be set to “0” and field 518 may be set to “2”.

The field 520, referred to as MLCRecordsTableAbsent, comprises a length of one bit, and is used to inform the receiver 210 whether the superframe 300 carries an MLC records table.

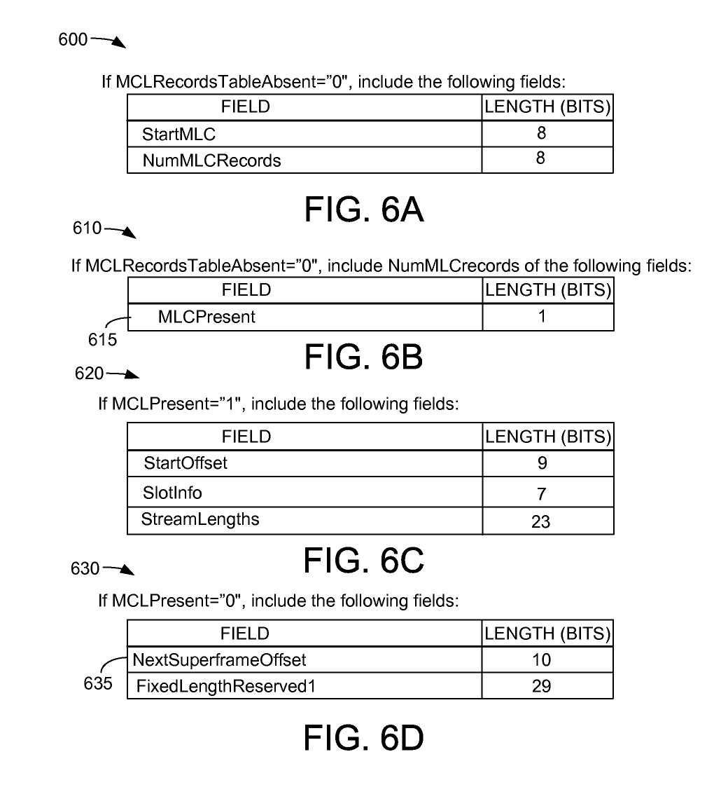

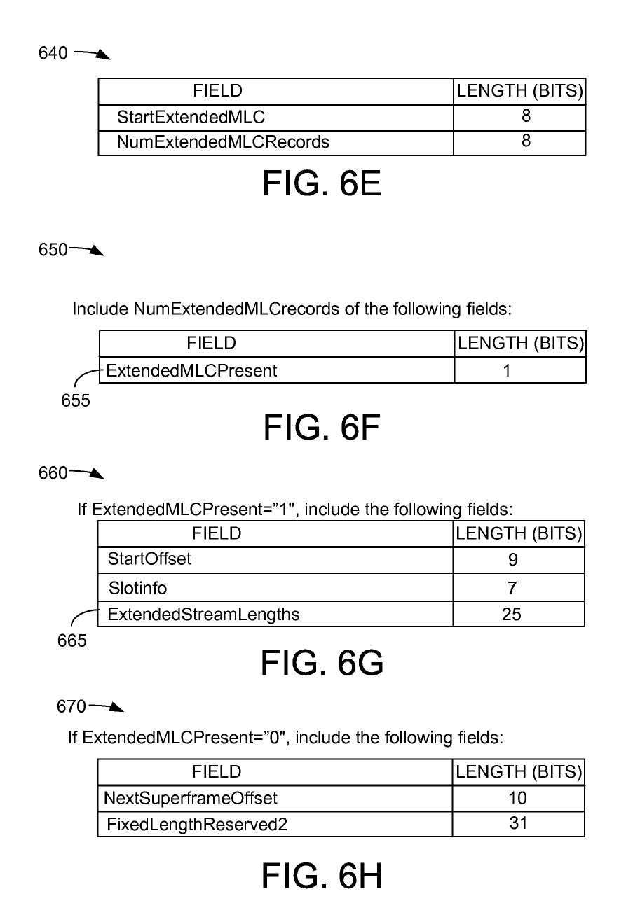

FIGS. 6A through 6D are diagrams illustrating various additional fields of the SystemParameters Message 500 of FIG. 5 as they relate to an MLC Records Table. In an embodiment, the additional fields can be added to an MLC in a “MAC trailer.” The diagram 600 illustrates a case where if the MLCRecordsTableAbsent field 520 (FIG. 5) is equal to logic “0”, then a StartMLC field having a length of eight (8) bits and a NumMLCRecords field having a length of eight (8) bits are included. When backward compatibility from a PHY Type 2 device to a PHY Type 1 device is desired, the StartMLC field, the NumMLCRecords field, and an MLC Records Table (FIG. 7) should always be present, and the MLCRecordsTableAbsent field 520 should be set to “0”. This bit may be set by the infrastructure in deployments with the minimum protocol version (field 516) set to “2”.

FIG. 6B shows a diagram 610 illustrating a case where if the MLCRecordsTableAbsent field 520 is equal to a logic “0”, then the NumMLCRecords of the field 615 (MLCPresent) is included. The field 615 has a length of one bit.

FIG. 6C shows a diagram 620 illustrating a case where if the MLCPresent field 615 (FIG. 6B) is equal to logic “1”, then the following fields are included: StartOffset, having a length of nine (9) bits; SlotInfo, having a length of seven (7) bits; and StreamLengths, having a length of 23 bits.

FIG. 6D shows a diagram 630 illustrating a case where if the MLCPresent field 615 (FIG. 6B) is equal to logic “0”, then the following fields are included; NextSuperframeOffset field 635, having a length of 10 bits; and FixedLengthReserved1, having a length of 29 bits.

FIGS. 6E through 6H are diagrams illustrating various additional fields of the SystemParameters Message 500 of FIG. 5 as they relate to an extended MLC Records Table.

FIG. 6E shows a diagram 640 illustrating an extended MLC Records table header including the following fields. StartExtendedMLC, having a length of eight (8) bits; and NumextendedMLCrecords, having a length of eight (8) bits.

FIG. 6F shows a diagram 650 illustrating a case where the NumExtendedMLCRecords of the following fields are included: ExtendedMLCPresent field 655, having a length of one (1) bit.

FIG. 6G shows a diagram 660 illustrating a case where if the ExtendedMLCPresent field 655 in FIG. 6F is equal to logic “1”, then the following fields are included: StartOffset, having a length of nine (9) bits; SlotInfo, having a length of seven (7) bits; and ExtendedStreamLengths, having a length of 25 bits. The ExtendedStreamLengths field 665 is made 2 bits longer than the StreamLengths field of FIG. 6C to allow a maximum number of packets on a larger stream that is 4 times greater than in the StreamLengths field. Further, the ExtendedStreamLengths field could be even longer (with no loss of generality) to increase the peak rate on medium and small streams as well.

FIG. 6H shows a diagram 670 illustrating a case where if the ExtendedMLCPresent field 655 in FIG. 6F is equal to logic “0”, then the following fields are included: NextSuperframeOffset, having a length of 10 bits; and FixedLengthReserved, having a length of 31 bits.

FIG. 7 is a block diagram 700 illustrating the relationship between an MLC, the OIS, and the control channel (CC). An MLC is generally shown using reference 710, the OIS is generally shown using reference 720 and the control channel is generally shown using reference 730.

In this example, the MLC 710 can be one of a physical type 1 mLC (PHY Type 1 mLC) or a physical type 2 mLC (PHY Type 2 mLC). In an embodiment, a portable communication device 200 that is capable of receiving a FLO transmission is only capable of decoding PHY Type 1 MLCs encoded using the protocols defined in Rev. 0 and A of TIA-1099. A portable communication device 200 that is capable of receiving a FLO-EV transmission is capable of decoding PHY Type 2 MLCs encoded using the protocols defined in Rev. B of TIA-1099. Further, it is possible that a single portable communication device 200 can be capable of receiving and decoding both a PHY Type 1 mLC and a PHY Type 2 mLC. Further still, it is possible that a single portable communication device 200 can be capable of receiving and decoding only a PHY Type 1 mLC, in which case all PHY Type 2 MLCs should be ignored. Moreover, it is possible that a single portable communication device 200 can be capable of receiving and decoding both a PHY Type 1 mLC and a PHY Type 2 mLC but not within the same superframe. Further, it is possible that a single portable communication device 200 can be capable of receiving and decoding a PHY Type 1 mLC, associated with a longer stream length (and thus higher peak rate), thus using the new trailer structure and the extended location table structure in OIS as defined in TIA 1099 Rev. B.

The OIS 720 is shown as including SystemParameters Message 722. The SystemParameters Message 722 is similar to the SystemParameters Message 500 described above. However, the SystemParameters Message 722 is illustrated in FIG. 7 as including an MLC Records Table 724 and an Extended MLC Records Table 726.

The MLC Records Table 724 includes the MLC location information of all flows listed in the Flow Description Message (FDM) 734. Similarly, the Extended MLC Records Table 726 includes the MLC location information of all flows listed in the Extended Flow description Message (EFDM) 736. If only PHY Type 2 flows are broadcast, then all MLC location information will be carried in the EFDM 736. The FDM 734 and the EFDM 736 also include information, such as for example, Tx_Mode, RF_ID, Stream number, RS Outer Code Rate (if applicable for PHY Type 1 transmit mode), and other attributes of the respective data stream identified in the FDM 734 and/or EFDM 736.

The FDM 734 includes the flow description of all flows that are assigned to MLCs with transmit modes 0 through 4 and 6 through 11 and whose MLC locations are listed in the MLC Records Table 724. Similarly, the EFDM 736 includes the flow description of all flows that are assigned to MLCs with transmit modes 0 through 4 and 6 through 11 and whose MLC locations are listed in the Extended MLC Records Table 726; and includes the flow description of all flows that are assigned to MLCs with transmit modes 64 through 72 (regular) and 80 through 91 (layered) and whose MLC locations are listed in the Extended MLC Records Table 726. Any MLC ID listed in the EFDM 736 will be in the extended MLC Records Table 726.

It is also possible to describe a PHY Type 1 mLC in the EFDM 736 and in the extended MLC Records Table 726. This is indicated in FIG. 7 using dotted lines to indicate that it is optional. Describing a PHY Type 1 mLC in the EFDM 736 and in the extended MLC Records Table 726 takes advantage of the higher peak rate available with a PHY Type 2 transmit mode. Furthermore, such MLCs would use the same MAC trailer syntax as a PHY Type 2 MLCs to be able to carry the longer length fields as defined in the extended MLC records table 726.

The flows described in the FDM 734 are decodable by PHY Type 1 devices and by PHY Type 2 devices. The flows described in the EFDM 736 are decodable by PHY Type 2 devices only.

Control channel information for accessing the FLO data stream is placed in the FDM 734 and the control channel information for accessing the FLO-EV data stream is placed in the EFDM.

The control channel 730 also includes an Extended Neighbor Description Message (ENDM) 738. The ENDM 738 contains the exact frequency that corresponds to their RF_ID (radio frequency identifier) of the control channel, and all the MLCs contained within the FDM 734 and the EFDM 736. The ENDM is readable by both FLO and FLO-EV devices.

The locations of FLO and FLO-EV MLCs within the superframe can be placed in either the MLC Record Table 724, or in the extended MLC Records Table 726. A reason for segregating the MLCs in the SystemParameter message 722 with respect to the MLC Record Table 724 and the extended MLC Records Table 726 is that such separation aids transmission security and allows a clear design demarcation. The segregation scheme is done at the control channel level and thus a FLO device will never attempt to capture an MLC_IDs that carries FLO-EV data.

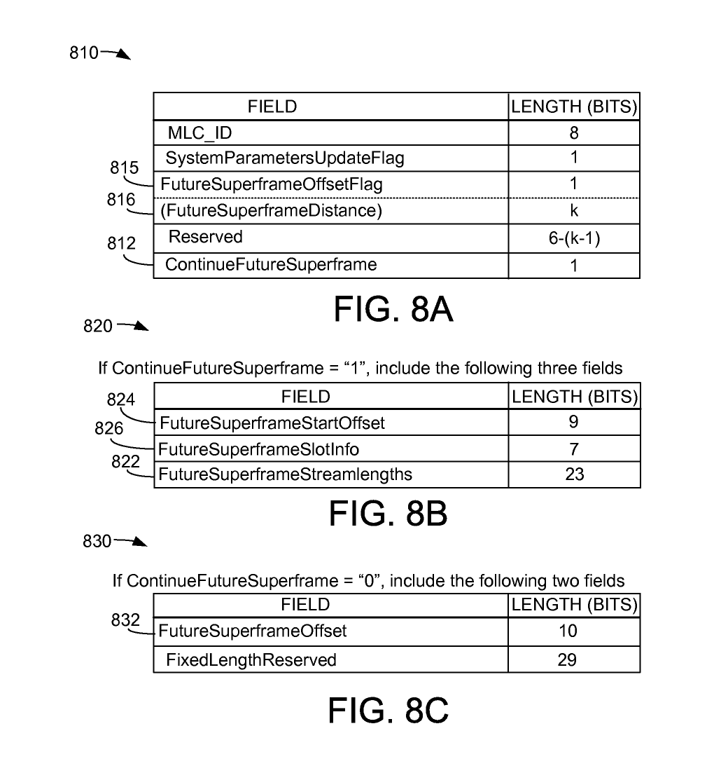

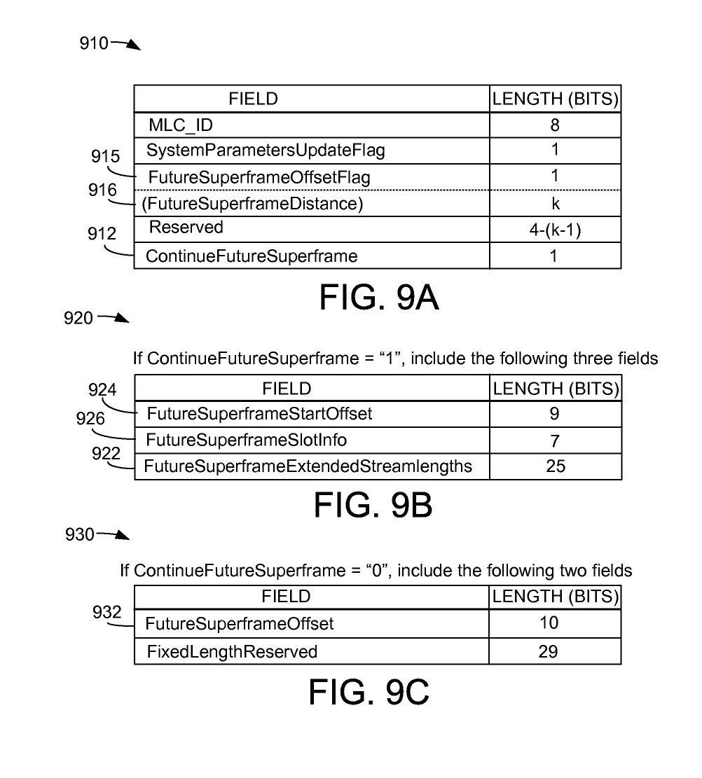

FIGS. 8A through 8C are diagrams illustrating various additional fields of the SystemParameters Message 500 of FIG. 5. The terminology “Future” to describe certain fields in FIGS. 8A through 9C is used interchangeably with the terminology “Next” used to describe corresponding fields in FIGS. 6A through 6H. Since the PHY Type 2 MLCs are encoded using a long turbo code spanning the entire superframe, their decoding requires the buffering of all the information received within a superframe and pertaining to these MLCs. For this reason, the decoding time of PHY Type 2 MLCs may be longer than that of PHY Type 1 MLCs. Therefore, the media access control (MAC) layer trailer in a PHY Type 2 mLC may not be decoded in sufficient time to allow for decoding the MLC in a subsequent superframe. The diagram 810 illustrates an additional MAC trailer added to the SystemParameters Message 500 of FIG. 5. The diagram 810 shows an additional field 812, referred to as ContinueFutureSuperframe, having a length of one (1) bit. The field 812 is used to indicate if there is a gap of at least one superframe where an MLC corresponding to the present service is not present. If the field 812 is set in a PHY Type 1 environment, the MLC is not present in the next superframe. If the field 812 is set in a FLO-EV environment, the MLC is not present two (2) superframes from the current superframe.

The diagram 810 also shows an additional field 815, referred to as FutureSuperframeOffsetFlag, having, in an embodiment, a length of one (1) bit. When set, the FutureSuperframeOffsetFlag indicates that the MLC information contained in the MAC layer trailer of an MLC present in superframe n points to the properties of the same MLC in superframe n+2. By default, the value of the FutureSuperframeOffsetFlag can be set to “0” for MLCs encoded using PHY Type 1, and set to “1” for MLCs encoded using PHY Type 2.

Alternatively, the FutureSuperframeOffsetFlag field 815 may be referred to as a “FutureSuperframeDistance” field 816 having a length of “k” bits, where k can be 4 or 8 bits. The FutureSuperframeDistance field allows for a more general implementation where the decoding latencies are not a major concern, and where the MAC trailer found in superframe n can point to superframe n+m, where m, depending on implementation, can take values of, for example, between 1 (for FutureSuperframeDistance=0) to 16 (for FutureSuperframeDistance=15), or higher for k=8.

FIG. 8B is a diagram 820 illustrating a case where if the ContinueFutureSuperframe field 812 is equal to logic “1”, then a FutureSuperframeStartOffset field 824 having a length of nine (9) bits; a FutureSuperframeSlotInfo field 826 having a length of seven (7) bits; and a FutureSuperframeStreamlengths field 822 having a length of 23 bits are included, and are used to describe the MLC occurrence in the “next referenced superframe”, where the referenced superframe is described by the FutureSuperframeOffsetFlag field 815 in one embodiment, or by the FutureSuperframeDistance flag 816 in another embodiment.

FIG. 8C is a diagram 830 illustrating a case where if the ContinueFutureSuperframe field 812 is equal to logic “0”, then a FutureSuperframeOffset field 832 having a length of 10 bits; and a FixedLengthReserved field having a length of 29 bits is included, such that the MAC trailer location information for the MLC is for the superframe whose start time is specified by the value in the FutureSuperframeOffset field 832. Therefore, if the MLC corresponding to the current one is missing in the referenced superframe, the FutureSuperframeOffset field 832 is used to indicate how long after that referenced superframe the MLC will be present again.

The FutureSuperframeOffset field 832 (FIG. 8C) and the NextSuperframeOffset field 635 in FIG. 6D refer to the subject MLC and its specific superframe-to-superframe behavior. For example, if an MLC is completely missing in one superframe, in the corresponding OIS the MLCPresent field 615 is set to =0 (FIG. 6B) and the FutureSuperframeOffset field 832 is set to =L (where L>0), which specifies when the MLC will be present again. Similarly, in the embedded OIS (MAC trailer) corresponding to this MLC, the ContinueFutureSuperframe field 812 is set to =0 and the FutureSuperframeOffset field 832 is set to =L. In this manner, the MAC layer trailer signals that the MLC will not be there in the “referenced superframe”, but will appear again L superframes later.

The FutureSuperframeOffsetFlag field 815 appears only in the MAC trailer, and indicates whether the trailer information present in the subject superframe n pertains to the subsequent superframe n+1 (FutureSuperframeOffsetFlag=0) or the second subsequent superframe n+2 (FutureSuperframeOffsetFlag=1). The FutureSuperframeOffsetFlag field 815 maintains a constant value for a given MLC all the time, regardless of whether the MLC is temporarily missing. The value (0 or 1) in the FutureSuperframeOffsetFlag field 815 typically depends on the PHY Type used to encode the subject MLC: PHY Type 1 typically corresponds with value 0 and PHY Type 2 typically corresponds with value 1. Keeping the value at zero allows backward compatibility with Rev. 0 and Rev. A compliant waveforms and corresponding devices.

FIGS. 9A through 9C are diagrams illustrating various additional fields of the SystemParameters Message 500 of FIG. 5. FIGS. 9A through 9C are similar to FIGS. 8A through 8C, but include fewer reserved bits and additional Streamlength bits for FLO-EV data. Devices that are denoted as PHY Type 2 devices may require a longer decoding time than PHY Type 1 devices. Therefore, the media access control (MAC) layer trailer may not be decoded in sufficient time to allow for decoding the MLC in a subsequent superframe. The diagram 910 illustrates an additional trailer added to the SystemParameters Message 500 of FIG. 5. The diagram 910 shows an additional field 912, referred to as ContinueFutureSuperframe, having a length of one (1) bit. When set, the field 912 signals that the MLC corresponding to the service carried on the current MLC is present in the “referenced superframe” as well.

The diagram 910 also shows an additional field 915, referred to as the FutureSuperframeOffsetFlag, having, in an embodiment, a length of one (1) bit. When set, the FutureSuperframeOffsetFlag indicates that the MLC information contained in the MAC layer trailer of an MLC present in superframe n points to the properties of the same MLC in superframe n+2. By default, the value of the FutureSuperframeOffsetFlag can be set to “0” for MLCs encoded using PHY Type 1, and set to “1” for MLCs encoded using PHY Type 2.

Alternatively, the FutureSuperframeOffsetFlag field 915 may be referred to as a “FutureSuperframeDistance” field 916 having a length of “k” bits, where k can be 4 or 8 bits. The FutureSuperframeDistance field allows for a more general implementation where the decoding latencies are not a major concern, and where the MAC trailer found in superframe n can point to superframe n+m, where m, depending on implementation, can take values of, for example, between 1 (for FutureSuperframeDistance=0) to 16 (for FutureSuperframeDistance=15), or higher for k=8. Depending on the embodiment, the FutureSuperframeOffsetFlag or the FutureSuperframeDistance field serve to define what is the “next referenced superframe” after the current superframe.

FIG. 9B is a diagram 920 illustrating a case where if the ContinueFutureSuperframe field 912 is equal to logic “1”, then a FutureSuperframeStartOffset field having a length of nine (9) bits; a FutureSuperframeSlotInfo field having a length of seven (7) bits; and a FutureSuperframeExtendedStreamlengths field 922 having a length of 25 bits are included, such that the MAC trailer location information for the MLC is for the superframe whose start time is 2 seconds after the start time of the superframe in which the trailer appears. The FutureSuperframeExtendedStreamlengths field 922 includes two additional bits than does the FutureSuperframeStreamlengths field 822 of FIG. 8B.

FIG. 9C is a diagram 930 illustrating a case where if the ContinueFutureSuperframe field 912 is equal to logic “0”, then a FutureSuperframeOffset field 932 having a length of 10 bits; and a FixedLengthReserved field having a length of 29 bits are included, such that the MAC trailer location information for the MLC is for the superframe whose start time is specified by the value in FutureSuperframeOffset field 832. Therefore, if the MLC corresponding to the current one is missing in the referenced superframe, the FutureSuperframeOffset field 932 is used to indicate how long after that referenced superframe the MLC will be present again.

The FutureSuperframeOffset field 932 (FIG. 9C) and the NextSuperframeOffset field 635 in FIG. 6D refer to the subject MLC and its specific superframe-to-superframe behavior. For example, if an MLC is completely missing in one superframe, in the corresponding OIS the MLCPresent field 615 is set to =0 (FIG. 6B) and the FutureSuperframeOffset field 932 is set to =L (where L>0), which specifies when the MLC will be present again. Similarly, in the embedded OIS (MAC trailer) corresponding to this MLC, the ContinueFutureSuperframe field 912 is set to =0 and the FutureSuperframeOffset field 932 is set to =L. In this manner, the MAC trailer signals that the MLC will not be there in the “referenced superframe”, but will appear again L superframes later.

The FutureSuperframeOffsetFlag field 915 appears only in the MAC trailer, and indicates whether the trailer information present in the subject superframe n pertains to the subsequent superframe n+1 (FutureSuperframeOffsetFlag=0) or the second subsequent superframe n+2 (FuttureSuperframeOffsetFlag=1). The FutureSuperframeOffsetFlag field 915 maintains a constant value for a given MLC all the time, regardless of whether the MLC is missing temporarily. The value (0 or 1) in the FutureSuperframeOffsetFlag field 915 typically depends on the PHY Type used to encode the MLC in question: PHY Type 1 typically corresponds with value 0 and PHY Type 2 corresponds with value 1. Keeping the value at zero allows backward compatibility with Rev. 0 and Rev. A compatible waveforms and corresponding devices.

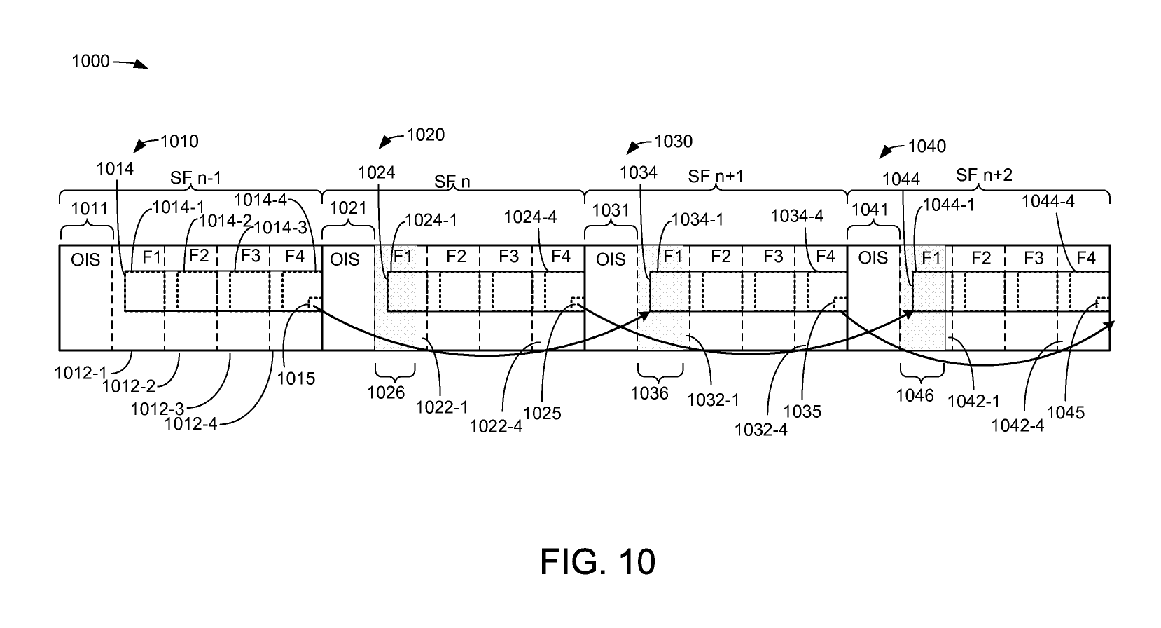

FIG. 10 is a diagram illustrating 1000 illustrating a portion of a data stream received by a portable communication device 200. The data stream 1000 can comprise a number of superframes, such as the superframe 300 described in FIG. 3. In FIG. 10, a series of superframes 1010, 1020, 1030, and 1040 are illustrated in sequence. The superframe 1020 can be referred to as superframe “n”, the superframe 1010 can be referred to as the superframe “n−1.” Similarly, the superframe 1030 will be referred to as superframe “n+1” and the superframe 1040 will be referred to as superframe “n+2.”

Each superframe in FIG. 10 is similarly constructed. For example, the superframe 1010 includes an OIS portion 1011, and four frames 1012-1, 1012-2, 1012-3, and 1012-4.

For example purposes only, MLC 1014 is used in superframe 1010 to carry information about a particular service. The same service is represented by MLC 1024 in frame 1020, MLC 1034 in frame 1030, MLC 1044 in frame 1040, and so forth. In practice, each frame may include more than one MLC and may include MLCs encoded using PHY Type 1, PHY Type 2, or PHY Type 1 and PHY Type 2 simultaneously. As an example only, the superframe 1010 includes an MLC 1014, which is shown in dotted lines as being divided across the four frames as MLC portions 1014-1, 1014-2, 1014-3 and 1014-4. The MLC 1014 is a single entity comprising multiple code blocks (not specifically illustrated, as they are understood by those having ordinary skill in the art) and multiple turbo packets. The MLC 1014 is distributed across the four frames by dividing the information in the MLC 1014 into four (4) substantially equal parts. In PHY Type 1 waveforms, this division is done across turbo packet boundaries. Since the MLC trailer is always contained in the last portion of the last turbo packet, the trailer itself would physically be contained to one frame only in FLO mode: frame 4 in 16/14 and 16/16 RS code rates, or frame 3 in 16/12 RS code rate.

In FLO-EV mode, the trailer is again part of the last turbo packet, but the interleaving structure is such that the contents of each turbo packet are “spread” across the entire superframe, in order to maximize time diversity. Thus the bits used to represent the MAC layer trailer 1015 corresponding to the MLC 1014 may be physically spread across the superframe 1010; however, for simplicity of illustration the Mac layer trailer 1015 is represented as a localized “dotted square” at the end of the MLC portion 1014-4 in FIG. 10.

The superframes 1020, 1030 and 1040 are similarly constructed with OIS portions 1021, 1031 and 1041, frames 1022, 1032 and 1042; MLCs 1024, 1034 and 1044; and MAC trailers 1025, 1035 and 1045, respectively. The MLCs 1014, 1024, 1034, 1044, etc. pertain to the same data stream that is divided into these MLCs across time. The MAC trailers 1015, 1025, 1035, 1045, etc., include a portion of the OIS information that relates to the position of the respective MLC in subsequent superframes, as shown in FIGS. 8A through 8C and 9A through 9C. Knowing the location of the MLCs in a subsequent superframe removes the need to decode the OIS portion (1021, 1031, 1041, etc.) for each subsequent superframe, thus reducing receiver processing and minimizing power consumption.

In one embodiment, the MAC trailers used for PHY Type 1 MLCs present in superframe n point to the corresponding MLCs present in superframe n+1. Similarly, in one embodiment, the MAC trailers used for PHY Type 2 MLCs present in superframe n point to the corresponding MLCs present in superframe n+2, as shown in FIG. 10. The gap in this reference may be signaled using the FutureSuperframeOffsetFlag field (815, 915) or the FutureSuperframeDistance field (816, 916) shown in FIG. 8A for MAC trailers consistent with PHY Type 1 and FIG. 9A for MAC trailers for PHY Type 2.

Using the superframe 1010 as an example that also applies to the superframes 1020, 1030 and 1040, in a FLO-EV network employing a PHY Type 2 transmit mode, it may not be possible to decode the MAC trailer 1015 during the time period occupied by the superframe 1010. Therefore, in accordance with an embodiment of the system and method for signaling overhead information in a network, the MAC trailer 1015 is decoded during a decoding interval 1026 within the superframe 1020. In an embodiment, the OIS information may be decoded within approximately the first 100 ms; however, the decoding may not happen at the beginning of the superframe, but after the OIS portion of the superframe. The time period of 100 ms is used as an example only. Other time periods can be used to decode the MAC trailer 1015 in the beginning, or other portion, of a subsequent superframe. In this embodiment, the MLC location information contained in the MAC trailer 1015 pertains to the location of the MLC 1034 in superframe 1030, as by the time the MAC trailer 1015 is recovered (e.g., at the end of interval 1026), MLC 1024 in superframe 1020 might already be in the process of being received. Therefore, embedded OIS for PHY Type 2 MLCs appearing in the superframe 1010 may be decoded during the first frame of the superframe 1020, and may carry the FutureSuperframeStartOffset, FutureSuperframeSlotInfo, and FutureSuperframeExtendedStreamlengths (FIG. 9B) pertaining to MLC 1034 appearing in the superframe 1030. Embedded OIS for PHY Type 1 MLCs may carry information about the same MLC located in the next superframe. For example, trailer 1015 in MLC 1014 would point to MLC 1024, etc.

In the case of acquiring or reacquiring a communication channel, there are two possibilities. For the case of a one (1) second delay where the OIS portion embedded in the MAC trailer 1015 pertains to the corresponding MLC 1024 in the subsequent superframe 1020, the system is acquired by acquiring a single OIS information. For example, using FIG. 10, assume the device is prompted to acquire a FLO system with PHY Type 1 only transmission sometime during the superframe 1010. The system is acquired by: (a) decoding the OIS 1021 at the beginning of superframe 1020, (b) decoding the control channel contained within superframe 1020. Thus, a single OIS acquisition is sufficient. Furthermore, if a user prompts the reception of service delivered on MLCs 1014, 1024, 1034, 1044, etc., in FIG. 10, and this prompt is received by the device during the superframe 1030, the device only acquires OIS 1041 at the beginning of superframe 1040 in order to start decoding MLC 1044 and so forth.

For the case of a two (2) second delay, found mostly in PHY Type 2 systems, where the OIS portion embedded in the MAC trailer 1015 carries information about the corresponding MLC 1034 in the second subsequent superframe 1030, then at least two consecutive OIS information portions are acquired and processed to bootstrap decoding the data stream. This is because the OIS 1021, for example, provides information used to decode MLC 1024 in superframe 1020, but the trailer 1025 only provides information about the corresponding MLC 1044 in superframe 1040. Therefore, OIS information 1031 is also acquired to facilitate decoding of MLC 1034 in superframe 1030. In another embodiment, the subsequent superframe can be a specified number “m” superframes away from the subject superframe. The specified number m can comprise values that can be described using k bits (i.e., the “k” bits of the FutureSuperframeDistance field (816, 916 referred to in FIGS. 8A and 9A) and is used to allow for situations where the decoding latencies might be longer than one superframe, and longer encoding schemes are used to further exploit time diversity benefits.

In one implementation, decoding both PHY Type 1 and PHY Type 2 MLCs simultaneously (on the same RF channel and using the shared Turbo decoding resources) may impose further restrictions on the device architecture or the MLC scheduling. In an alternative embodiment, only PHY Type 2 MLCs can be broadcast and decoded in the decoding interval 1026 (1036, 1046, etc.), as their reception leads to data buffering and does not lead to a conflict on Turbo decoder resources. In an embodiment, the decoding interval can be a 100 ms duration occurring after the OIS interval 1021 (1031, 1041, etc.) during which only PHY Type 2 MLCs can be scheduled, transported and decoded so that the receiver 210 can operate in FLO-EV only mode during this period, and then operate in FLO or FLO-EV mode during the rest of the frame and superframe. Thus, at least the first part of a frame can be used to transport, receive and decode only FLO-EV data, and the rest can be any mix of the two when a simple implementation of the receiver to support both FLO and FLO-EV is desired.

A first data stream can have a corresponding first data type and a second data stream may have a corresponding second data type, where the first data type and the second data type can be different and are received simultaneously. Decoding the first data type can occur during the decoding interval 1026 during the superframe immediately following superframe n and the second data type may be decoded immediately upon reception. The decoding interval 1026 can be used to schedule, transmit and receive the first data stream to the exclusion of any data stream and a remainder of the at least one superframe can be used to schedule, transmit and receive data streams corresponding to either data type, as well as to decode the second data stream corresponding to the second data type.

In an alternative embodiment, a PHY Type 1 mLC can also be scheduled anywhere within a frame 1022-1 for example, but its decoding during frame 1022-1 may no longer happen at an arbitrary point, but should be synchronized to happen after decoding of the PHY Type 2 MLCs received during the previous superframe 1010. This decoding interval 1026 may span the majority of frame 1 (1022-1) thus pushing the PHY Type 1 mLC decoding into frame 2, etc. This scheme dictates separate data buffering for both FLO and FLO-EV MLCs received during the first two frames (1022-1 and 1022-2, or 1032-1 and 1032-2, etc.). In this manner, no restrictions are placed on the scheduling, transmitting and receiving of first and second data streams corresponding to either data type, as long as the appropriate buffering of the data corresponding to both data types and the appropriate scheduling of the decoder resources are used at the receiver in order to prevent resource collisions during the stream decoding. The decoding registers that buffer the data streams can be registers 223, 225, 233 and 235 associated with the AGC element 222, AFC element 226, FFT element 228 and LLR generator 232, respectively, shown in FIG. 2.

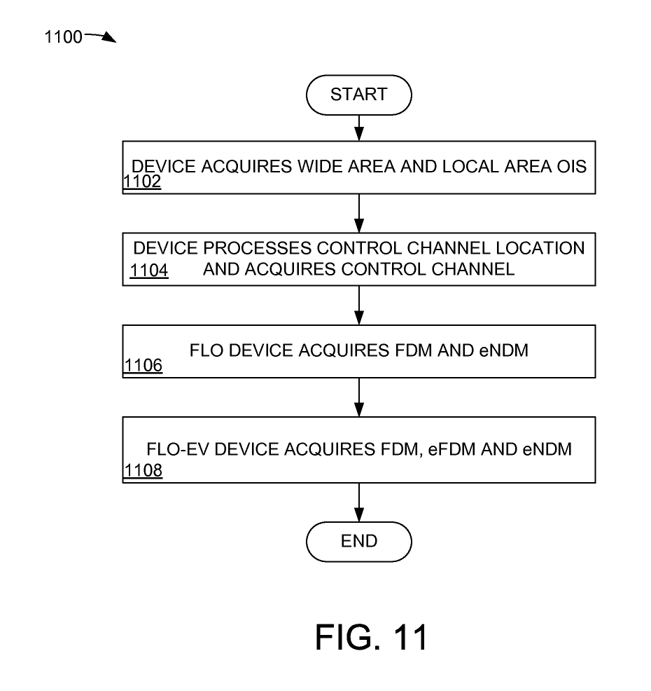

FIG. 11 is a flowchart describing an exemplary power up sequence of a portable communication device 200 of FIG. 1. In block 1102 the portable communication device 200 acquires the wide-area OIS and the local area OIS in the superframe 300 (FIG. 3).

In block 1104, the portable communication device 200 processes the control channel (CC) location and acquires the control channel. In block 1106, a portable communication device 200 configured to receive FLO data acquires the flow description message (FDM) and the extended neighbor description message (ENDM) associated with the PHY Type 1 mLC that carries the FLO data.

In block 1108, a portable communication device 200 configured to receive FLO-EV data acquires the flow description message (FDM), the extended flow description message (EFDM) and the extended neighbor description message (ENDM) associated with the PHY Type 2 mLC that carries the FLO-EV data.

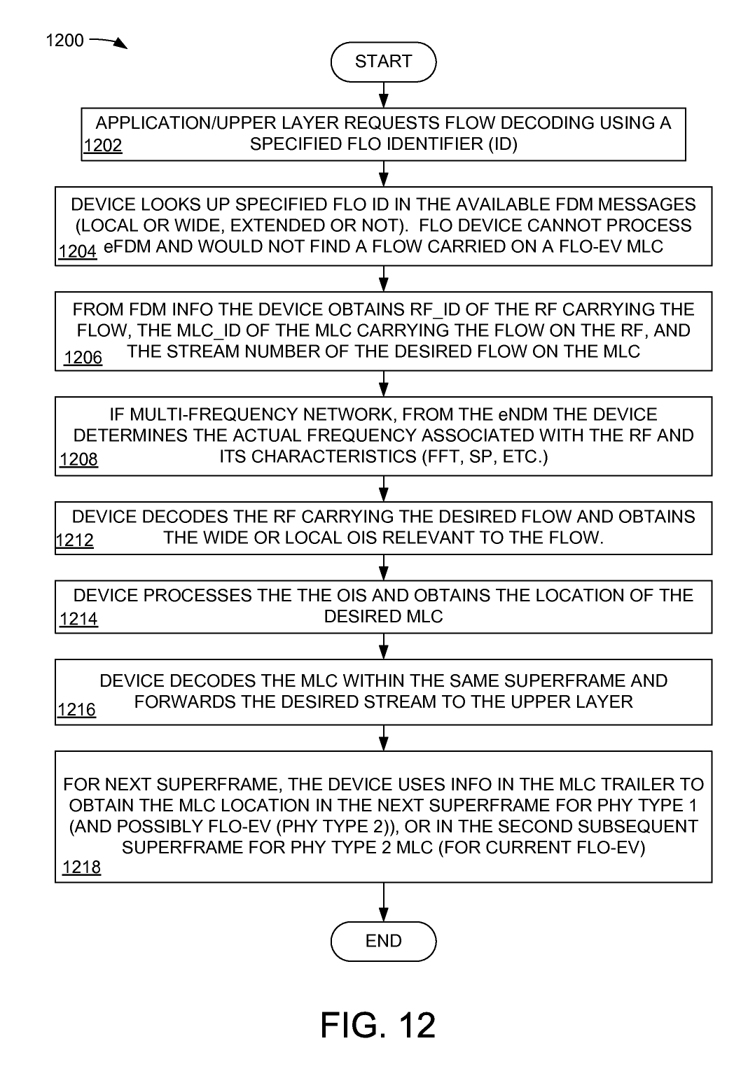

FIG. 12 is a flowchart describing flow acquisition in a portable communication device 200 of FIG. 1. In block 1202, an application/upper layer (not shown for simplicity) requests flow decoding using a specified flow identifier (FLO_ID). The FLO_ID is provided in the FDM and in the EFDM (FIG. 7) Regarding backward compatibility, the portable communication device 200 will receive the SystemParameters message 500 and 505 (FIG. 5) and will use the MinProtocolVersion field 516 and the ProtocolVersion field 518 to determine whether it can decode the subject RF channel. If the MinProtocolVersion field 516 is set to 0, then FLO devices, that accept version 0 and 1, can decode this RF, and the CC is sent using a PHY Type 1 transmit mode. This implies a dependency between the CC transmit mode and backward compatibility. The dependency exists because, in an embodiment, a single CC is implemented. In an alternative embodiment in which a CC is sent using both a PHY Type 1 transmit mode and a PHY Type 2 transmit mode, the second CC information is added at the end of the message similarly to the extended MLC location table. If backward compatibility is not desired, then the MinProtocolVersion field 516 and ProtocolVersion field 518 can be set to 2, and then the CC mode can be a PHY Type 2 transmit mode if desired.

In block 1204, the portable communication device 200 looks up the specified FLO_ID in the available FDM 734 or EFDM 736 (local or wide). A portable communication device configured to process only FLO data cannot process the EFDM 736 and would not find a flow carried on a FLO-EV MLC.

In block 1206, from the FDM 734, the portable communication device 200 obtains the RF_ID of the radio frequency signal carrying the flow, the MLC ID of the MLC carrying the flow on the radio frequency signal, and the stream number of the desired flow on the MLC.

In block 1208, if a multiple frequency network is implemented, from the extended neighbor description message 738, the portable communication device 200 determines the actual frequency associated with the RF and its radio characteristics.

In block 1212, the portable communication device 200 decodes the radio frequency signal carrying the desired flow and obtains the wide or local OIS relevant to the particular flow.

In block 1214, the portable communication device 200 processes the OIS and obtains the locations of the desired MLC.

In block 1216, the portable communication device 200 decodes the MLC within the same superframe and forwards the desired stream to the application/upper layer.

In block 1218, for the next superframe, the portable communication device 200 uses information in the MLC trailer to obtain the MLC location in the next superframe for FLO, or in the second subsequent superframe for a FLO-EV MLC.

While various embodiments of the invention have been described, it will be apparent to those of ordinary skill in the art that many more embodiments and implementations are possible that are within the scope of the invention. The system and method for providing additional content to a program stream is not limited to a specific type of additional content or to a specific type of content delivery.

What is claimed is:

1. A system for signaling overhead information in a network, comprising:
a receiver configured to receive a radio frequency communication signal comprising at least one superframe, the at least one superframe comprising overhead information that identifies a location of a first data stream carried in the at least one superframe; and
a trailer associated with the first data stream, the trailer including at least a portion of the overhead information that identifies the location of the first data stream in a subsequent superframe without the receiver processing the overhead information in the subsequent superframe.

2. The system of claim 1, wherein the subsequent superframe is one superframe in duration later than the at least one superframe.

3. The system of claim 1, wherein the subsequent superframe is two superframes in duration later than the at least one superframe.

4. The system of claim 3, wherein the subsequent superframe is a specified number of superframes away from the at least one superframe, and wherein the specified number of superframes comprises values that can be described using k bits and is used where decoding latencies are longer than one superframe.

5. The system of claim 3, wherein the trailer is decoded by the receiver during a portion of the superframe immediately following the at least one superframe, and wherein the trailer identifies the location of the first data stream in the subsequent superframe.

6. The system of claim 1, further comprising a second data stream, the first data stream having a corresponding first data type and the second data stream having a corresponding second data type, where the first data type and the second data type can be different and are received simultaneously, wherein decoding the first data type comprises allocating a dedicated time interval during the superframe immediately following the at least one superframe, and wherein the second data type may be decoded immediately upon reception.

7. The system of claim 6, wherein a portion of the at least one superframe is used to schedule, transmit and receive the first data stream corresponding to the first data type to the exclusion of any data stream corresponding to the second data type, and a remainder of the at least one superframe is used to schedule, transmit and receive data streams corresponding to either data type, as well as to decode the second data stream corresponding to the second data type.

8. The system of claim 7, wherein the portion of the at least one superframe comprises a defined duration of time at the beginning of a first data frame.

9. The system of claim 6, where no restrictions are placed on the scheduling, transmitting and receiving the first and second data streams corresponding to either data type, as long as the appropriate buffering of the data corresponding to both data types and the appropriate scheduling of the decoder resources are used at the receiver to prevent resource collisions during the stream decoding.

10. A method for signaling overhead information in a network, comprising:
receiving a radio frequency communication signal comprising at least one superframe, the at least one superframe comprising overhead information that identifies a location of a data stream in the at least one superframe;
processing the overhead information in the at least one superframe to obtain the location of the data stream;
associating a trailer with the data stream, the trailer including at least a portion of the overhead information that identifies the location of the data stream in a subsequent superframe; and
identifying a location of the data stream in the subsequent superframe without processing the overhead information in the subsequent superframe.

11. The method of claim 10, wherein the subsequent superframe is one superframe in duration later than the at least one superframe.

12. The method of claim 10, wherein the subsequent superframe is two superframes in duration later than the at least one superframe.

13. The method of claim 12, wherein the subsequent superframe is a specified number of superframes away from the at least one superframe, and wherein the specified number of superframes comprises values that can be described using k bits and is used where decoding latencies are longer than one superframe.

14. The method of claim 12, further comprising decoding the trailer during a portion of the superframe immediately following the at least one superframe, and wherein the trailer identifies the location of data stream in the subsequent superframe.

15. The system of claim 10, further comprising a second data stream, the first data stream having a corresponding first data type and the second data stream having a corresponding second data type, where the first data type and the second data type can be different and are received simultaneously, wherein decoding the first data type comprises allocating a dedicated time interval during the superframe immediately following the at least one superframe, and wherein the second data type may be decoded immediately upon reception.

16. The system of claim 15, wherein a portion of the at least one superframe is used to schedule, transmit and receive the first data stream corresponding to the first data type to the exclusion of any data stream corresponding to the second data type, and a remainder of the at least one superframe is used to schedule, transmit and receive data streams corresponding to either data type, as well as to decode the second data stream corresponding to the second data type.

17. The method of claim 16, wherein the portion of the at least one superframe comprises a defined duration of time at the beginning of a first data frame.

18. The method of claim 15, where no restrictions are placed on the scheduling, transmitting and receiving the first and second data streams corresponding to either data type, as long as the appropriate buffering of the data corresponding to both data types and the appropriate scheduling of the decoder resources are used at the receiver to prevent resource collisions during the stream decoding.

19. A system for signaling overhead information in a network, comprising:
a transmitter configured to transmit a radio frequency communication signal comprising at least one superframe, the at least one superframe comprising overhead information that identifies a location of a first data stream carried in the at least one superframe; and
a trailer associated with the first data stream, the trailer including at least a portion of the overhead information that identifies the location of the first data stream in a subsequent superframe without the receiver processing the overhead information in the subsequent superframe.

20. The system of claim 19, wherein the subsequent superframe is one superframe in duration later than the at least one superframe.

21. The system of claim 19, wherein the subsequent superframe is two superframes in duration later than the at least one superframe.

22. The system of claim 21, wherein the subsequent superframe is a specified number of superframes away from the at least one superframe, and wherein the specified number of superframes comprises values that can be described using k bits and is used where decoding latencies are longer than one superframe.

23. The system of claim 21, wherein the trailer is decoded by a receiver during a portion of the superframe immediately following the at least one superframe, and wherein the trailer identifies the location of the data stream in the subsequent superframe.

24. The system of claim 19, further comprising a second data stream, the first data stream having a corresponding first data type and the second data stream having a corresponding second data type, where the first data type and the second data type can be different and are received simultaneously, wherein decoding the first data type comprises allocating a dedicated time interval during the superframe immediately following the at least one superframe, and wherein the second data type may be decoded immediately upon reception.

25. The system of claim 24, wherein a portion of the at least one superframe is used to schedule, transmit and receive the first data stream corresponding to the first data type to the exclusion of any data stream corresponding to the second data type, and a remainder of the at least one superframe is used to schedule, transmit and receive data streams corresponding to either data type, as well as to decode the second data stream corresponding to the second data type.

26. The system of claim 25, wherein the portion of the at least one superframe comprises a defined duration of time at the beginning of a first data frame.

27. The system of claim 24, where no restrictions are placed on the scheduling, transmitting and receiving the first and second data streams corresponding to either data type, as long as the appropriate buffering of the data corresponding to both data types and the appropriate scheduling of the decoder resources are used at the receiver to prevent resource collisions during the stream decoding.
